(19) United States
(12) Patent Application Publication
(10) Pub. No.: US 2023/0149250 A1
(43) Pub. Date: May 18, 2023

(54) Soft Tissue Treatment Instrument

(71) Applicant: Carl R. Hanson, Happy Valley, OR (US)

(72) Inventor: Carl R. Hanson, Happy Valley, OR (US)

(21) Appl. No.: 17/724,475

(22) Filed: Apr. 19, 2022

Related U.S. Application Data
(63) Continuation-in-part of application No. 16/179,132, filed on Nov. 2, 2018, now Pat. No. 11,085,638.

(51) Int. Cl. A61H 7/00

(52) U.S. Cl. CPC A61H 7/003

(57) ABSTRACT

A body engaging manipulation instrument for use by a practitioner on body parts of an individual being treated formed of body engaging sections connected to a central gripping panel. A centrally located, raised gripping member having an upper, dome shaped gripping area that extends outwardly from an upper surface of the gripping panel and a recessed gripping area having a shape complementary to the raised gripping area located on a lower surface of the gripping panel. The body engaging sections are connected to the gripping panel at an angle greater than 90 degrees and are formed with a shaped tissue engaging edge corresponding to the tissue structure of a person being treated.

### BACKGROUND OF THE INVENTION

The present invention relates to hand held tools and in particular to an instrument for the mobilization and treatment of human body soft tissue.

Soft tissue therapy is performed on an individual such as an athlete or similar active person, normally by a trainer or bodyworker. Typically, the soft tissue areas of the body, such as muscles, tendons, fascia or ligaments, react or break down after strenuous exercise, overuse, strenuous training or as a result of an injury. During a recovery or healing process, this tissue often causes fibrous adhesions or scar tissue having limited flexibility that ultimately will affect the individual's use of the injured area thereby impacting performance or just the well- being of the person. Repair of these areas may be done using the hands and fingers of a practitioner trained in the art of physical, soft tissue therapy, including various massage and deep tissue massage as well as cross frictional massage and rolfing. Using hands-on techniques to manipulate and mobilize the soft tissue often results in difficulty in applying the appropriate amount of pressure to achieve the desired result.

Too little pressure will result in insufficient healing and too much pressure can result in additional injury. To overcome these shortcomings when performing soft tissue healing arts, a wide variety of tools and instruments have been developed for use by healthcare practitioners, physical therapists, occupational therapists, chiropractors and massage therapists to treat areas of soft tissue restriction and degeneration. These tools are used to break down fascial restrictions, including fascial adhesions and scar tissue, allowing for the return of normal movement of the muscle, ligament, tendon and/or joints. This technique is enhanced and supported by an assisted soft tissue mobilization instrument to promote healing by increasing blood flow to the area of restriction, which, in turn, promotes an increase of nutrients flowing into and waste products flowing out of the degenerated tissue area.

These prior art instruments are generally shaped to match the particular shape of the soft tissue being treated. These tools have various curved surfaces including round, arcuate and parabolic shaped soft tissue engaging surfaces that enable a practitioner to apply essentially even pressure across the particular area being treated to break-up and loosen the fibrous and other material sought to be eliminated.

Prior art includes U.S. Pat. No. 5,366,437 to Graston, U.S. Pat. No. 6,077,239 to Lin, D 696,414 to Hayami , D 686,333 to Innes, D 678,539 to Narson, D 645,568 to Walker, D 638,549 and D 634,022 to Scappaticci, and 2015/0265486 to Fiore.

Applicant's own invention disclosed in co-pending application Ser. No. 15/406,709, filed Jan. 14, 2017 shows another soft tissue mobilization instrument that is a further improvement of the known prior art.

Whereas the soft tissue engaging surfaces of these tools typically are well designed to engage the soft tissue, the overall shape of the tool is often awkward to handle requiring the practitioner to constantly grip and re-grip to tool in order to use it to maximum potential. These tools usually require lubricant between the skin of the person being treated and the working edges of the tool. This results in difficulty handling the tool by the practitioner.

### SUMMARY OF THE INVENTION

The present invention relates to a soft tissue mobilization instrument preferably having oppositely disposed, dual soft tissue body engaging sections and a central gripping panel for engaging and treating an area on the body of the person being treated. The instrument is designed for precise and even application of pressure against the surface of the body during treatment. The body engaging sections are disposed at an angle at opposite sides of the central gripping panel whereby as one of the working members is used for a treatment, the gripping panel provides a gripping area disposed at an angle to facilitate gripping by the practitioner. This structure enables a practitioner to locate the instrument against the soft tissue surface being treated in a precise and comfortable position so the soft tissue mobilization movements can be easily performed with minimum manipulation of the instrument during the process. The gripping panel further includes a gripping member centrally spaced away from the opposite soft tissue working sections where lubricant is normally applied. This eliminates gripping problems of the more conventional tools where the lubricant is applied adjacent the area that is gripped during use. The gripping member has a raised, dome shaped upper gripping area and a recessed gripping area in the form of a cavity on the lower surface of the gripping panel having a complementary shape to the upper gripping area on the upper surface of the gripping member.

The working, tissue engaging sections of the present invention are formed as two generally flat, planar body engaging sections connected along their respective inner longitudinal edges to the central gripping panel. Each working section is arranged at an angle with respect to the central gripping panel. Preferably the working sections are attached at an angle greater than 90 degrees, preferably at 135 and 150 degrees, although it will be appreciated the attaching angle for either of the working sections may be slightly altered while maintaining similar structural advantages.

The working, body engaging edges of the sections may assume a variety of different shapes that engage the treatment areas of the body. For example, the sections may have an outer edge that is curved and may be either slightly concave or convex. Other tissue engaging sections may include a variety of curved or parabolic configurations. Typically, tissue engaging sections on opposite sides of the gripping panel do not have the same shape or configuration to provide increased variety for engagement of the soft tissue of the individual being treated. Preferably the gripping panel is approximately 3 times wider than the attached tissue engaging sections to provide maximum workability and comfort to the practitioner using the instrument.

The angle between the working, tissue engaging sections of the instrument and the central gripping panel provides a structure that allows for an improved grip by the practitioner, particularly when working in and around the curves and nooks of the body. In addition to the angular relationship between the tissue engaging, working sections and the central gripping panel, the gripping member of the central gripping panel section of the instrument, in the form of the raised gripping member and recessed groove, fits the fingers of the practitioner gripping the instrument to facilitate a smooth, evenly applied pressure to the area being treated.

A preferred instrument in accordance with the present invention is made of solid, heavy, polished metal with smooth, radiused edges that engage the individual being treated. A suitable metal, such as stainless steel or the like, preferably has significant weight that enhances the practitioner's ability to feel the depth and strength of the soft tissue restrictions in the large fibrous areas of the body, such as the planter surface of the foot, IT band and the hamstring/tendon areas of the human body. It will be appreciated other materials such as ceramic, glass or plastic may be used with equal effectiveness.

The present invention includes various embodiments of the instrument whereby the working sections may have various structural differences and may be interchanged to fit particular body shapes such by altering the size and shape of the edge of the working sections that engage the soft tissue of the person being treated.

Other alternate embodiments use an edge of the one of the working sections of the instrument that is formed with a plurality of parabolic shapes closely located and having an opening therebetween whereby the tissue being treated can be positioned between the parabolic shapes to facilitate treatment. The number of parabolic shapes may vary and depends upon the way the instrument is used. Typically, there may be two, three or four of these shapes on a working section of the instrument.

Among the objects of the present invention is the provision of a soft tissue mobilization instrument that is used by a health care practitioner to manipulate and mobilize soft tissue of an individual.

Another object is the provision of a soft tissue mobilization instrument that is easy to hold by a practitioner during a treatment of the soft tissue of an individual.

Still another object is the provision of a soft tissue mobilization instrument that promotes healing in an area of restriction of the soft tissue of an individual by promoting blood flow in the soft tissue.

These and other objects will become apparent with reference to the following detailed description and accompanying drawings of the instrument of the present invention.

### DESCRIPTION OF THE DRAWINGS

FIG. 1 is a top perspective view of an embodiment of a soft tissue mobilization instrument of the present invention.

FIG. 2 is a bottom perspective view of the instrument of FIG. 1.

FIG. 3 is a top plan view of the instrument of FIG. 1.

FIG. 4 is an end view of the instrument of FIG. 1.

FIG. 5 is a sectional view taken along line 5-5 of FIG. 4.

FIG. 6 is a sectional view taken along line 6-6 of FIG. 4.

FIG. 7 is an end view of a second embodiment of the present invention.

FIG. 8 is an end view of a third embodiment of the present invention.

FIG. 9 is a perspective view of a fourth embodiment of the present invention.

FIG. 10 is a perspective view of a fifth embodiment of the present invention.

FIG. 11 is a perspective view of a sixth embodiment of the present invention.

FIG. 12 is a perspective view of a seventh embodiment of the present invention.

### DESCRIPTION OF THE PREFERRED EMBODIMENTS

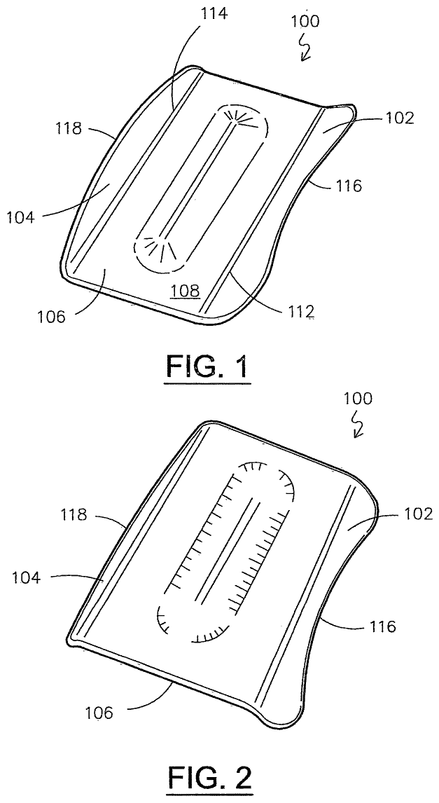

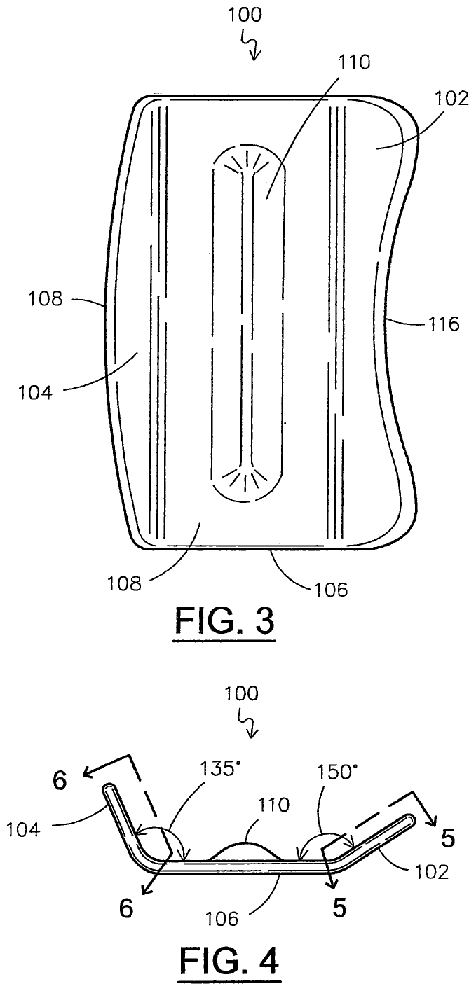

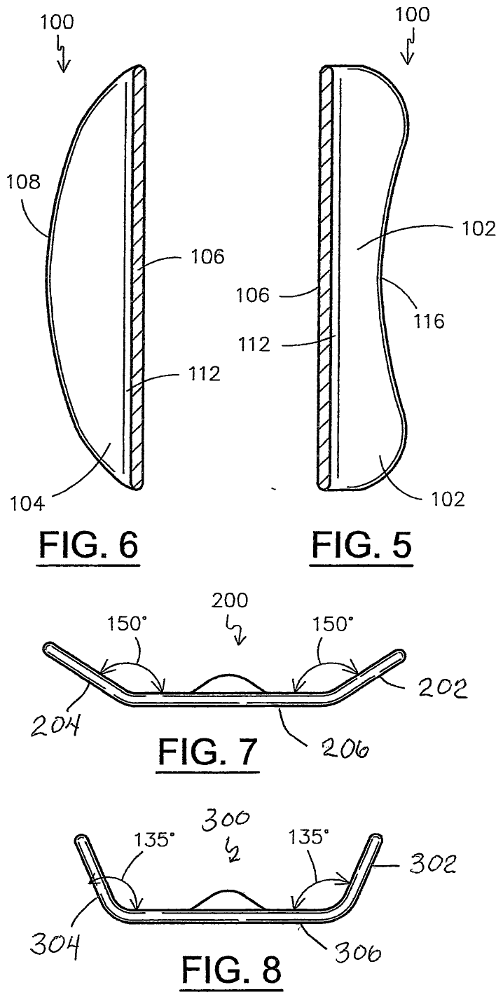

Referring to FIGS. 1 to 6 of the drawings, a preferred embodiment of the soft tissue mobilization instrument 100 is formed with dual flat, planar, soft tissue body engaging sections 102 and 104, oppositely disposed on a central gripping panel 106, for engaging and treating an area on the body of the person being treated that are designed for precise and even engagement of treatment pressure during treatment. The body engaging sections 102 and 104 are connected along their respective inner longitudinal edges 112 and 114 to the sides of the central gripping panel 106. The tissue engaging sections 102 and 104 are disposed at an angle with respect to the central gripping panel 106 at opposite sides thereof whereby when one of the body engaging sections 102 or 104 is used for a treatment, the gripping panel 106 facilitates gripping by the practitioner to locate one of the soft tissue body engaging sections 102 or 104 in a precise and comfortable position with the tissue being treated so the soft tissue mobilization movements can be easily performed with essentially no manipulation of the instrument 100 during the process.

The gripping panel 106 includes a gripping member 110 that has a first gripping area that is in the form of a raised, dome shape extending above an upper surface of the gripping panel 106 and centrally spaced from and parallel to the inner longitudinal sides 112 and 114 of the gripping panel 106. The raised gripping area of the gripping member 110 is in a horizontal plane that intersects with the soft tissue, body engaging sections 102 and 104 as seen in FIG. 4 of the drawings. This positions the raised area of the gripping member 110 on the same upper side of the gripping panel 106 as the body engaging sections 102 and 104. The gripping member 110 is approximately two thirds of the length of the gripping panel 106 providing sufficient area to enable the fingers of the user to obtain a solid grip of the instrument 100 at a location where lubricant is normally applied thereby eliminating the gripping problems of more conventional tools where the lubricant is applied on or adjacent the area that is gripped during use.

0032 Depending upon the location, size and shape of the tissue area being treated, it is often preferable to grip and hold the instrument 100 with the fingers of the user engaging the bottom surface of the gripping panel 106. The gripping member 110 has a second recessed gripping area at the bottom surface of the gripping panel 106 that is a complementary in size and shape to the raised gripping area of the gripping member 110 on the upper surface 108 of the gripping panel 106. The recess 111 is sized to enable a user to position fingers into the recess 111 providing a secure grip on the instrument 100 during tissue treatment. It follows that the gripping member 110 has a dual function with working areas that can be readily gripped by the user on both the upper and lower surfaces of the gripping panel 106 enabling the instrument 100 to be used with the tissue engaging surfaces 102 and 104 to be angled toward and away from the tissue being treated.

The body engaging sections 102 and 104 are attached at an angle greater than 90 degrees, preferably at 135 and 150 degrees, see FIG. 4, although it will be appreciated the attaching angle for either of the body engaging sections 102 and 104 may be slightly altered while maintaining similar structural and working advantages.

The working, tissue engaging, outer peripheral edges 116 and 118 of the body engaging sections 102 and 104 may assume a variety of different shapes that engage the treatment areas of the body. For example, the section 102 is shown with an outer edge 116 that is curved in a slightly concave configuration. Section 104 has an outer edge 118 in a slightly convex configuration. Both shaped sections 102 and 104 may be used to engage the soft tissue of the person being treated.

The angle between the body engaging sections 102 and 104 of the instrument 100 and the central gripping panel 106 may be different while maintaining an efficient use of the instrument 100 depending upon the treatment to be done.

Referring to FIG. 7, an instrument 200 uses body engaging sections 202 and 204 both disposed at an angle of 150 degrees to a central gripping panel 206.

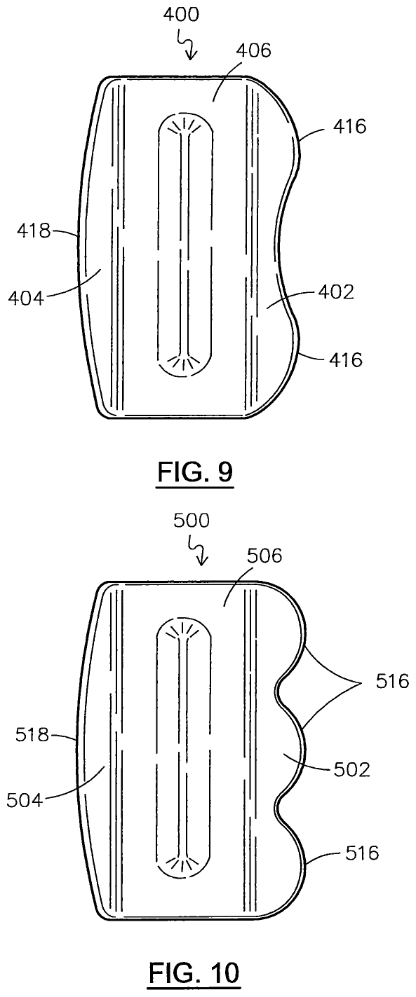

FIG. 8 discloses an instrument 300 having body engaging sections 302 and 304 both disposed at an angle of 135 degrees with respect to a central gripping panel 306.

Another embodiment of the instrument 400 is shown in FIG. 9. A first body engaging section 402 is formed of a plurality of tissue engaging, parabolic humps 416 that are angularly attached to a central gripping panel 406. In this embodiment the number of humps is two, as seen in the drawing. An opposite body engaging section 404, is also angularly attached to the central gripping panel 406 and includes a generally convex edge 418 for engaging the tissue of a person being treated.

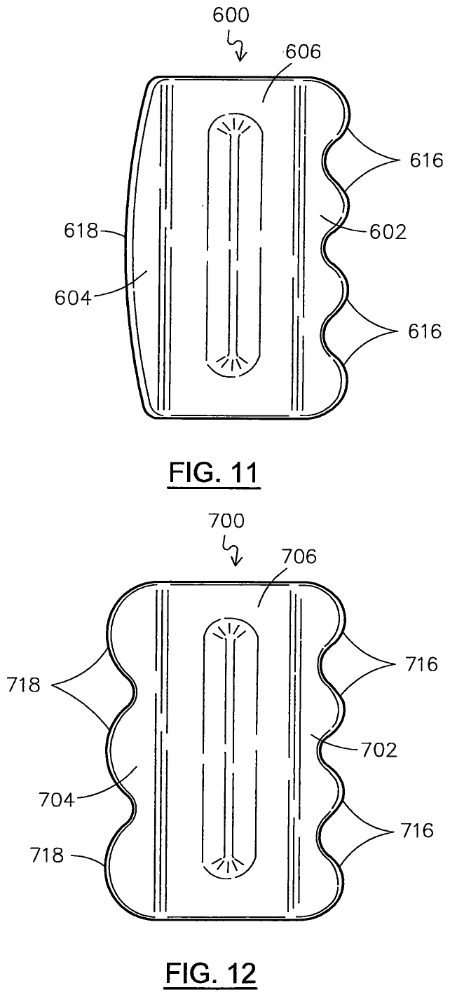

Another embodiment of an instrument 500 is shown in FIG. 10. In this embodiment, a first body engaging section 502 is formed of three tissue engaging, parabolic humps 516 that are angularly attached to a central gripping panel 506. An opposite body engaging section 504, is also angularly attached to the central gripping panel 506 and includes a generally convex edge 518 for engaging the tissue of a person being treated.

Still another similar embodiment of an instrument 600 is shown in FIG. 11. A first body engaging section 602 is formed of a plurality of four tissue engaging, parabolic humps 616 that are angularly attached to a central gripping panel 606. An opposite body engaging section 604, is also angularly attached to the central gripping panel 606 and includes a generally convex edge 618 for engaging the tissue of a person being treated.

FIG. 12 shows an instrument 700 having a first body engaging section 702 with four multiple tissue engaging, parabolic humps 716 on one side of a gripping panel 706 and a second, opposite body engaging section 704 also having three multiple tissue engaging humps 718 on an opposite side of a central gripping panel 706.

The various instruments presented above are designed to provide maximum comfort and workability for the practitioner using them to treat individual needs of persons being treated. Preferably, the central gripping panel is approximately three times larger than the connected tissue engaging sections. This preferred ratio positions the instrument squarely in the palm of the user such that the working section opposite the section being used for treatment fits comfortable in the user's fingers without digging that could apply undue pressure to the user's hands during treatment.

Of course the overall size of any instrument can be varied to accommodate the hand size of the practitioner. A man with large hands will use an instrument of a larger size whereas a woman with small hands will use a significantly smaller instrument. Whatever the size of the instrument, the ratio between the gripping panel and working sections remains essentially the same for maximum workability and comfort.

It will be appreciated that other various modifications can be made and that the tissue engaging edges of the various working sections and the angles thereof are totally interchangeable in keeping within the scope of the invention as defined in the limitations of the following claims.

1. A body engaging manipulation instrument for use by a practitioner for treatment of body parts of an individual comprising:
a central gripping panel being generally planar in shape and oriented in a first plane and having a generally rectangular shape formed by opposite, elongated sides, an upper edge and a lower edge, said panel being further defined by said elongated sides being substantially greater in length than said upper edge and said lower edge;
said gripping panel including an upper surface and a lower surface;
a gripping member centrally located on said gripping panel; said gripping member extending approximately two thirds of the distance between the upper edge and the lower edge of said gripping panel; said gripping member oriented parallel to and spaced from said elongated sides of said gripping panel;
said gripping member further defined as having a first gripping area in the form of an elongated dome shape extending upwardly from and located above said upper surface of said gripping panel; said gripping member having a second gripping area located at and recessed inwardly into said lower surface of said gripping panel;
said body engaging manipulation instrument characterized by at least one tissue engaging member having an edge to engage the tissue being treated; said one tissue engaging member being longitudinally connected along an entire length of one elongated side edge of said gripping panel; and, said one tissue engaging member located in a second planar direction above said upper surface of said gripping panel and at an angle with respect to said first planar direction of said gripping panel.

2. The body engaging manipulation instrument of claim 1 wherein said gripping member is further defined as intersecting a horizontal plane relative to said upper surface of said gripping panel that passes through said at least one tissue engaging member.

3. The body engaging manipulation instrument of claim 1 further including a second tissue engaging member connected to .a second elongated side edge opposite said one elongated side edges of said gripping panel; said second tissue engaging member being planar in shape and angularly oriented in a third planar direction with respect to said first planar direction of said gripping panel.

4. The body engaging manipulation instrument of claim 1 wherein said first planar configuration of said gripping panel and said second planar configuration of at least one tissue engaging member are oriented at an angle of approximately 135 degrees.

5. The body engaging manipulation instrument of claim 1 wherein said edge of said at least one tissue engaging member is curved.

6. The body engaging manipulation instrument of claim 5 wherein said edge of said at least one tissue engaging member is concave.

7. The body engaging manipulation instrument of claim 5 wherein said edge of said at least one tissue engaging member is convex.

8. The body engaging manipulation instrument of claim 5 wherein said edge of said at least one tissue engaging member is formed of a plurality of parabolic humps.

9. A body engaging manipulation instrument for use by a practitioner for treatment of body parts of an individual comprising:
a central gripping panel being generally planar in shape and oriented in a first planar direction and including an upper surface and a lower surface; the gripping panel further defined having a generally rectangular shape formed by opposite, elongated side edges of equal length, an upper edge and a lower edge of equal length, wherein the opposite elongated side edges are substantially greater in length than the length of the upper edge and the lower edge;
a gripping member centrally located on said gripping panel; said gripping member extending approximately two thirds of the distance between the upper edge and the lower edge of said gripping panel; said gripping member oriented parallel to and spaced from said elongated sides of said gripping panel;
said gripping member further defined as having a first gripping area in the form of an elongated dome shape extending upwardly from and located above said upper surface of said gripping panel; said gripping member having a second gripping area located at and recessed inwardly into said lower surface of said gripping panel;
said body engaging manipulation instrument having tissue engaging members each including a treatment edge to engage the tissue being treated; said tissue engaging members being longitudinally connected along an entire length of said elongated side edges; said tissue engaging members located in another planar direction above said upper surface of said gripping panel and at an angle with respect to said first planar direction of said gripping panel.
